(19) United States
(12) Patent Application Publication
(10) Pub. No.: US 2021/0006592 A1
(43) Pub. Date: Jan. 7, 2021

(54) Phishing Detection based on Interaction with End User

(71) Applicant: Ericom Software Ltd., Jerusalem (IL)

(72) Inventors: Eran HEYMAN, Closter, NJ (US); John PETERSON, Morgan Hill, CA (US); Beny HADDAD, Jerusalem (IL); Erez PASTERNAK, Modiin (IL)

(21) Appl. No.: 16/919,181

(22) Filed: Jul. 2, 2020

Related U.S. Application Data
(60) Provisional application No. 62/870,696, filed on Jul. 4, 2019.

(51) Int. Cl. H04L 29/06

(52) U.S. Cl. CPC H04L 63/1483; H04L 63/1416

(57) ABSTRACT

Computerized methods and systems receive, from a web client of a client device, a request, addressed to a web server, to retrieve a requested web resource hosted by the web server. An initial reputation associated with the requested web resource is determined. A user of the client device is prompted to respond to at least one generated query corresponding to the requested web resource, in response to the determined initial reputation. At least one response to the at least one generated query is received from the user. The initial reputation associated with the requested web resource is updated, based in part on the at least one response to the at least one generated query received from the user.

This application claims priority from U.S. Provisional Patent Application No. 62/870,696, filed Jul. 4, 2019, whose disclosure is incorporated by reference in its entirety herein.

### TECHNICAL FIELD

The present invention relates to methods and systems for detecting potential malware.

### BACKGROUND OF THE INVENTION

Malware is any software used to disrupt computer operations, gather sensitive information, or gain access to private assets residing in computer systems. This can lead to the malware creator or other unauthorized parties gaining access to the computer system and private information stored on the computer system being compromised. Malware includes computer viruses, worms, trojan horses, spyware, adware, key loggers, and other malicious programs. These programs can appear in the form of computerized code, scripts, and other software.

Phishing attacks are a particular type of malicious attack, in which a malicious actor attempts to trick a user of a computer system to gain unauthorized access to private or personally identifiable information stored on the computer system. Types of information typically targeted in a phishing attack include user login information and personal data, such as, for example, user credentials (e.g., user ID and password), financial information (e.g., credit card details, bank account details, etc.), and the like.

A fraudulent web page may be a look alike of a well-known web page or web site, so as to appear to the user as part of the well-known site. This may be accomplished by the fraudulent attacker hijacking a known web site via cross-site scripting, or by obtaining a domain name that is similar to that of a well-known web site.

### SUMMARY OF THE INVENTION

The present invention is directed to computerized methods and systems which detect potential phishing websites.

Embodiments of the present invention are directed to a method for detecting phishing web resources based on user feedback. The method comprises: receiving, from a web client of a client device, a request, addressed to a web server, to retrieve a requested web resource hosted by the web server; determining an initial reputation associated with the requested web resource; in response to determining the initial reputation, prompting a user of the client device to respond to at least one generated query corresponding to the requested web resource; and updating the initial reputation associated with the requested web resource, based in part on at least one response to the at least one generated query received from the user, to generate an updated reputation associated with the requested web resource.

Optionally, the method further comprises: generating the at least one generated query in response to determining the initial reputation.

Optionally, determining the initial reputation includes checking for the presence of at least one of a web address or a domain associated with the requested web resource in one or more obtained list containing at least one of web addresses or domains.

Optionally, determining the initial reputation includes assigning a numerical reputation score to the requested web resource that quantifies an amount of risk associated with the requested web resource.

Optionally, determining the initial reputation includes analyzing at least one of: at least one string character or feature of a web address that identifies the requested web resource, at least one string character or feature of a domain associated with the requested web resource, at least one input field of the requested web resource, at least one string character or feature of the requested web resource, or entropy of words or characters in a domain associated with the requested web resource.

Optionally, determining the initial reputation includes identifying at least one anomaly associated with the requested web resource.

Optionally, the generated at least one query is generated according to at least one of the least one anomaly or the initial reputation.

Optionally, the at least one generated query includes a plurality of queries, and the method further comprises: receiving a response to each query of the plurality of queries; and aggregating the received responses, and wherein updating the reputation includes modifying the initial reputation based in part on the aggregated responses.

Optionally, the initial reputation is represented by an initial reputation score, and the method further comprises: sending the request to retrieve the requested web resource if the initial reputation score satisfies a first threshold criterion; and blocking the request to retrieve the requested web resource if the initial reputation score satisfies a second threshold criterion.

Optionally, the updated reputation is represented by an updated reputation score, and the method further comprises: blocking the request to retrieve the requested web resource and adding at least one of a web address or a domain associated with the requested web resource to a black list if the updated reputation score satisfies a first threshold criterion; and sending the request to retrieve the requested web resource if the updated reputation score dissatisfies the first threshold criterion.

Optionally, the method further comprises: receiving, from a web client of a second client device, a request, addressed to the web server, to retrieve the requested web resource hosted by the web server; prompting a user of the second client device to respond to a second at least one generated query corresponding to the requested web resource; and updating the initial reputation associated with the requested web resource, based in part on: at least one response to the at least one generated query received from the user of the user computer, and at least one response to the second at least one generated query received from the user of the second user computer, to generate the updated reputation associated with the requested web resource.

Optionally, the method further comprises: notifying a user of the client device of the updated reputation associated with the requested web resource.

Optionally, the request to retrieve the web resource includes a request to open a web page.

Embodiments of the present invention are directed to a computer system for detecting phishing web resources based on user feedback. The computer system comprises: a storage medium for storing computer components; and a computerized processor for executing the computer components. The computer components comprise: one or more computer module configured for: receiving, from a web client of a client device, a request, addressed to a web server, to retrieve a requested web resource hosted by the web server; determining an initial reputation associated with the requested web resource; in response to determining the initial reputation, prompting a user of the client device to respond to at least one generated query corresponding to the requested web resource; and updating the initial reputation associated with the requested web resource, based in part on at least one response to the at least one generated query received from the user, to generate an updated reputation associated with the requested web resource.

Embodiments of the present invention are directed to a computer usable non-transitory storage medium having a computer program embodied thereon for causing a suitable programmed system to detect phishing web resources based on user feedback, by performing the following steps when such program is executed on the system. The steps comprise: receiving, from a web client of a client device, a request, addressed to a web server, to retrieve a requested web resource hosted by the web server; determining an initial reputation associated with the requested web resource; in response to determining the initial reputation, prompting a user of the client device to respond to at least one generated query corresponding to the requested web resource; and updating the initial reputation associated with the requested web resource, based in part on at least one response to the at least one generated query received from the user, to generate an updated reputation associated with the requested web resource.

Embodiments of the present invention are directed to a method for detecting phishing web resources based on user feedback. The method comprises: receiving, from a web client of a client device, a request, addressed to a web server, to retrieve a requested web resource hosted by the web server; obtaining an initial reputation score associated with the requested web resource; and if the initial reputation score satisfies at least one threshold criterion: generating at least one generated query corresponding to the requested web resource, prompting a user of the client device to respond to the at least one generated query, and updating the initial reputation score, based in part on at least one response to the at least one generated query received from the user, to generate an updated reputation score indicative of an updated reputation associated with the requested web resource.

Optionally, obtaining the initial reputation score includes identifying at least one anomaly associated with the requested web resource, and wherein the generated at least one query is generated according to at least one of the initial reputation score or the at least one anomaly.

Optionally, the method further comprises: receiving, from a web client of a second client device, a request, addressed to the web server, to retrieve the requested web resource hosted by the web server; prompting a user of the second client device to respond to a second at least one generated query corresponding to the requested web resource; and updating the initial reputation score, based in part on: at least one response to the at least one generated query received from the user of the user computer, and at least one response to the second at least one generated query received from the user of the second user computer, to generate the updated reputation score.

Optionally, the at least one generated query includes a plurality of queries, and the method further comprises: receiving a response to each query of the plurality of queries; and aggregating the received responses, and wherein updating the initial reputation score includes modifying the initial reputation score based in part on the aggregated responses to generate the updated reputation score.

Optionally, the method further comprises: sending the request to retrieve the requested web resource if the initial reputation score satisfies a first threshold criterion; and blocking the request to retrieve the requested web resource if the initial reputation score satisfies a second threshold criterion.

Optionally, the method further comprises: blocking the request to retrieve the requested web resource and adding at least one of a web address or a domain associated with the requested web resource to a black list if the updated reputation score satisfies a first threshold criterion; and sending the request to retrieve the requested web resource if the updated reputation score dissatisfies the first threshold criterion.

Embodiments of the present invention are directed to a computer system for detecting phishing web resources based on user feedback. The computer system comprises: a storage medium for storing computer components; and a computerized processor for executing the computer components. The computer components comprise: one or more computer module configured for: receiving, from a web client of a client device, a request, addressed to a web server, to retrieve a requested web resource hosted by the web server; obtaining an initial reputation score associated with the requested web resource; and if the initial reputation score satisfies at least one threshold criterion: generating at least one generated query corresponding to the requested web resource, prompting a user of the client device to respond to the at least one generated query, and updating the initial reputation score, based in part on at least one response to the at least one generated query received from the user, to generate an updated reputation score indicative of an updated reputation associated with the requested web resource.

Embodiments of the present invention are directed to a computer usable non-transitory storage medium having a computer program embodied thereon for causing a suitable programmed system to detect phishing web resources based on user feedback, by performing the following steps when such program is executed on the system. The steps comprise: receiving, from a web client of a client device, a request, addressed to a web server, to retrieve a requested web resource hosted by the web server; obtaining an initial reputation score associated with the requested web resource; and if the initial reputation score satisfies at least one threshold criterion: generating at least one generated query corresponding to the requested web resource, prompting a user of the client device to respond to the at least one generated query, and updating the initial reputation score, based in part on at least one response to the at least one generated query received from the user, to generate an updated reputation score indicative of an updated reputation associated with the requested web resource.

Embodiments of the present invention are directed to a method for detecting phishing web resources based on user feedback. The method comprises: receiving, from a web client of a client device, a request, addressed to a web server, to retrieve a requested web resource hosted by the web server; checking for the presence of at least one of a web address that identifies the requested web resource or a domain name associated with the requested web resource in at least one list, the at least one list comprising a plurality of elements having an associated common reputation, wherein the plurality of elements includes at least one of: one or more web address, or one or more domain name; and if at least one of the web address that identifies the requested web resource or the domain name associated with the requested web resource is present in the at least one list: generating at least one generated query corresponding to the requested web resource, prompting a user of the client device to respond to the at least one generated query, and updating an initial reputation associated with the requested web resource, based in part on at least one response to the at least one generated query received from the user, to generate an updated reputation associated with the requested web resource.

Embodiments of the present invention are directed to a computer system for detecting phishing web resources based on user feedback. The computer system comprises: a storage medium for storing computer components; and a computerized processor for executing the computer components. The computer components comprise: one or more computer module configured for: receiving, from a web client of a client device, a request, addressed to a web server, to retrieve a requested web resource hosted by the web server; checking for the presence of at least one of a web address that identifies the requested web resource or a domain name associated with the requested web resource in at least one list, the at least one list comprising a plurality of elements having an associated common reputation, wherein the plurality of elements includes at least one of: one or more web address, or one or more domain name; and if at least one of the web address that identifies the requested web resource or the domain name associated with the requested web resource is present in the at least one list: generating at least one generated query corresponding to the requested web resource, prompting a user of the client device to respond to the at least one generated query, and updating an initial reputation associated with the requested web resource, based in part on at least one response to the at least one generated query received from the user, to generate an updated reputation associated with the requested web resource.

Embodiments of the present invention are directed to a computer usable non-transitory storage medium having a computer program embodied thereon for causing a suitable programmed system to detect phishing web resources based on user feedback, by performing the following steps when such program is executed on the system. The steps comprise: receiving, from a web client of a client device, a request, addressed to a web server, to retrieve a requested web resource hosted by the web server; checking for the presence of at least one of a web address that identifies the requested web resource or a domain name associated with the requested web resource in at least one list, the at least one list comprising a plurality of elements having an associated common reputation, wherein the plurality of elements includes at least one of: one or more web address, or one or more domain name; and if at least one of the web address that identifies the requested web resource or the domain name associated with the requested web resource is present in the at least one list: generating at least one generated query corresponding to the requested web resource, prompting a user of the client device to respond to the at least one generated query, and updating an initial reputation associated with the requested web resource, based in part on at least one response to the at least one generated query received from the user, to generate an updated reputation associated with the requested web resource.

This document references terms that are used consistently or interchangeably herein. These terms, including variations thereof, are as follows:

A “computer” includes machines, computers and computing or computer systems (for example, physically separate locations or devices), servers, gateways, computer and computerized devices, processors, processing systems, computing cores (for example, shared devices), virtual machines, and similar systems, workstations, modules and combinations of the aforementioned. The aforementioned “computer” may be in various types, such as a personal computer (e.g. laptop, desktop, tablet computer), or any type of computing device, including mobile devices that can be readily transported from one location to another location (e.g. smartphone, personal digital assistant (PDA), mobile telephone or cellular telephone).

A “Uniform Resource Locator (URL)” is the unique address for a file, a web site or a web page, that is accessible on the Internet or other network, including a public or wide area network.

A “web page” is a collection of information provided by a web site, that is displayed to a user in a web client, such as a web browser. A “web site” is a collection of web pages identifiable by a common domain name and that is published on at least one web server. Within the context of this document, the term web page is used to refer to both a “web page” and a “web site” as defined above.

A “web resource” is any item that can be obtained from the world wide web. Such items include, for example, web sites, web pages, files, documents, electronic mail (e-mail), information from databases, and web services. A web resource is identifiable by a unique web address, namely a URL.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram illustrating a system environment in which an embodiment of the invention is deployed;

FIG. 2 is a diagram of the architecture of an endpoint client device that is used with embodiments of the present invention;

FIG. 3 is a diagram of an exemplary system according to embodiments of the present invention;

FIG. 4 is a flow diagram illustrating a process for detecting phishing web resources based on feedback from an endpoint client device according to embodiments of the present invention;

FIG. 5 is a flow diagram illustrating a process for detecting phishing web resources based on feedback from an endpoint client device according to other embodiments of the present invention

FIG. 6 is a flow diagram illustrating a process for detecting phishing web resources based on crowdsourced feedback from multiple endpoint client devices according to embodiments of the present invention.

### DESCRIPTION OF THE PREFERRED EMBODIMENTS

The present invention is directed to computerized methods and systems which detect potential phishing web pages. A system is deployed in the network pipeline between a web client of an endpoint client (i.e., client computer) and a web server that hosts one or more web resources. The system can be deployed at various points in the pipeline, for as example as part of a security product (e.g., a gateway, firewall, proxy server, ethernet switch, router, etc.), a web client plug-in, a piece of software installed on the endpoint client, a piece of software running on a remote (e.g., cloud) server linked to the endpoint client via a network, or a traffic capture device or application. The system receives requests (addressed to the web server) from the web client (e.g., web browser) of the endpoint client to retrieve a web resource, e.g., to open a requested web page or web site located at a web address (URL) hosted by the web server. The system ascertains the reputation of the web resource by performing a risk assessment to assess a level of risk associated with the web resource, in particular, the risk posed to the user of the endpoint client if the requested web resource is a phishing web resource (e.g., a phishing web page). Web resources deemed as having “high risk” are equivalently deemed as having a “poor reputation”, and web resources deemed as having “low risk” are equivalently deemed as having a “strong reputation”. The risk assessment is performed by determining an initial level of risk (and equivalently an initial reputation), and applying at least one rule to the requested web resource so as to check whether the initial reputation is of a sufficient reputation level or whether the initial level of risk is above a predetermined level of risk or falls within a specified risk category. In certain embodiments, the application of the at least one rule includes evaluating the initial level of risk or initial reputation against one or more threshold criteria. The initial level of risk or initial reputation may be determined based on information provided by an external reputation service that identifies potential phishing web resources by, for example, checking for anomalies in the web address or domain associated with the requested web resource. Alternatively, the initial level of risk may or initial reputation be determined by assigning a numerical reputation score that quantifies the risk/reputation, in which the reputation score is assigned by, for example, analyzing the web address or domain associated with the requested web resource to identify anomalies. If the initial reputation is not of a sufficient level, or if the initial level of risk is greater than the predetermined level of risk or falls within a specified risk category, the system dynamically generates one or more query corresponding to the requested web resource, and prompts the user (via the web client) to respond to the one or more query. The user response (or responses) is/are used by the system to re-assess the risk in order to provide an updated reputation of the requested web resource (i.e., an updated level of risk posed to the user of the endpoint client).

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

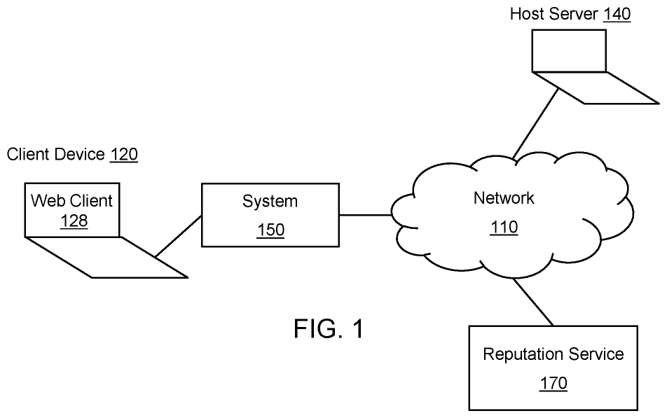

Refer now to FIG. 1, an illustrative example environment in which embodiments of the present disclosure may be performed over a network 110. The network 110 may be formed of one or more networks, including, for example, the Internet, cellular networks, wide area, public, and local networks. An endpoint client, for example, a user computer 120 (also referred to as a “client device”, “client computer”, or “client computer device”) is linked to the network 110

The embodiments include a system 150 that includes multiple modules which cooperate to provide mechanisms for receiving requests from a web client 128 of the user computer 120 that are addressed to a web server 140 hosting one or more web sites and/or web applications (generally referred to as web resources) in order to retrieve a web resource (e.g., open a web page) hosted by the web server 140, obtaining or determining an initial level of risk associated with the web resource requested from the web client 128 (i.e., the risk posed to the user computer 120 if the requested web resource is a phishing web resource), generating one or more queries (addressable to the user computer 120) corresponding to the requested web resource, prompting the user of the user computer 128 to respond to the generated queries, receiving responses to the generated queries from the user, determining an updated reputation (level of risk) based on the received response, and taking appropriate action based on the initial level of risk and/or the updated reputation (level of risk). Within the context of this document, the initial level of risk generally refers to the level of risk attributed to a web resource in response to the first request (by the web client 128) to retrieve the web resource during a session (e.g., browsing session).

The system 150 is deployed in the network pipeline between the web client 128 and the web server 140. In the illustrative example environment shown in FIG. 1, the system 150 is separate from the user computer 120. In such embodiments, the system 150 may be deployed as part of a gateway, a firewall, proxy server, ethernet switch, router, traffic capture device or any other system/device/service separate from the user computer 120 that sits in the pipeline between the user computer 120 and the web server 140. In other embodiments, the system 150 is executed as part of the user computer 120, and may be deployed, for example, as a piece of software installed on the user computer 120, or as a web client 128 plug-in, in particular a web browser plug-in. The system 150 may also be deployed as software running on a remote (e.g., cloud) server linked to the network 110.

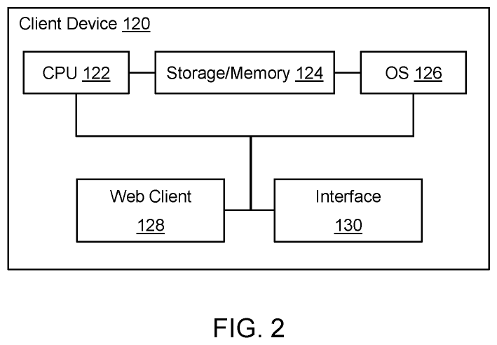

FIG. 2 shows the user computer 120 as an architecture. The user computer 120 includes a CPU 122, a storage/memory 124, an operating system (OS) 126, a web client 128, and a network interface 130 for exchanging packets with the network 110. All of the components of the user computer 120 are connected or linked to each other (electronically and/or data), either directly or indirectly.

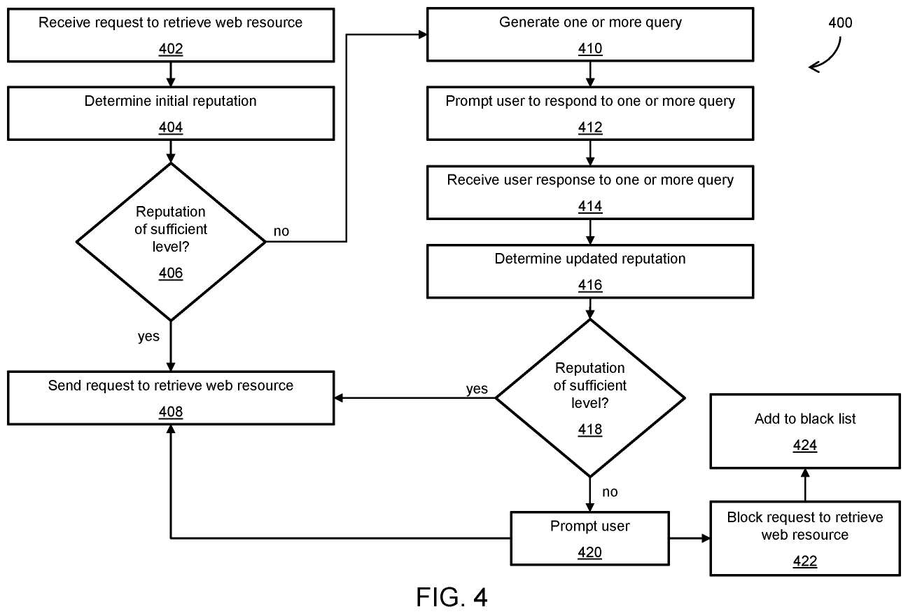

The CPU 122 and the storage/memory 124, although shown as a single component for representative purposes, may be multiple components. The CPU 122 is formed of one or more processors, including microprocessors, for performing the user computer 120 functions, including executing the functionalities and operations of the web client 128 and the OS 126. In embodiments in which the system 150 is deployed as a web client 128 plug-in or a piece of software installed on the user computer 120, these functionalities and operations also include the functionalities and operations of the system 150, including the processes shown and described in the flow diagrams of FIGS. 4-6. The processors are, for example, conventional processors, such as those used in servers, computers, and other computerized devices. For example, the processors may include x86 Processors from AMD and Intel, Xeon® and Pentium® processors from Intel, as well as any combinations thereof.

The storage/memory 124 is any conventional storage media. The storage/memory 124 stores machine executable instructions for execution by the CPU 122, to perform the processes of the present embodiments. The storage/memory 124 also includes machine executable instructions associated with the operation of the components of the user computer 120, including the web client 128. In embodiments in which the system 150 is deployed as a web client 128 plug-in or a piece of software installed on the user computer 120, the machine executable instructions are associated with the operation of the system 150, including instructions for executing the processes of FIGS. 4-6, detailed herein.

The OS 126 may be any conventional computer operating system, such as those available from Microsoft of Redmond Wash., commercially available as Windows® OS, such as Windows® XP, Windows® 7, MAC OS and iOS from Apple of Cupertino, Calif., or Linux based operating systems such as those available from Google of Menlo Park Calif., commercially available as Android OS. The OS 126 may also be implemented as a real-time operating system (RTOS).

The web client 128 is, for example, any computer system application that can communicate with web servers in order to access data on the world wide web via web servers (such as the web server 140). In a particular non-limiting implementation, the web client 128 is implemented as a web browser. Such web browsers include, but are not limited to, Microsoft® Internet Explorer®, Google Chrome™, and Mozilla Firefox®. Without loss of generality, the term web client and web browser can be used interchangeably throughout the remaining sections of the present disclosure.

The interface 130 may be one or more network interfaces which allows the flow of network traffic to and from the user computer 120 via, for example, the exchange of data packets. When the user of the user computer 120 requests to retrieve a requested web resource (i.e., requests to navigate to a web address that identifies the requested web resource, e.g., requests to open a requested web page), the request is sent via the web client 128, which sends a request message, such as a hypertext transfer protocol (HTTP) request message, through the network interface 130. In the absence of the system 150, the request message is forwarded over the network 110 to the web server 140, and the web server 140 responds in kind with a response message (e.g., HTTP response message) and web content corresponding to the requested web resource.

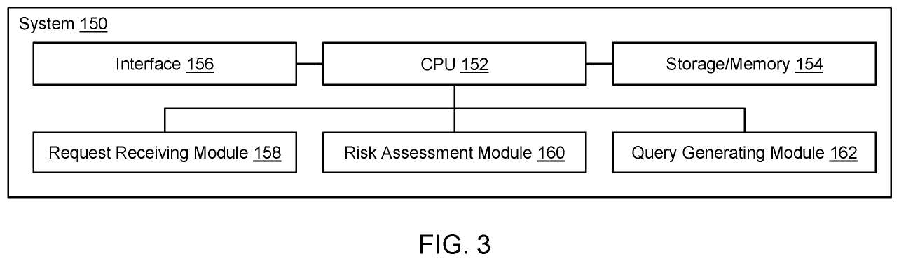

FIG. 3 shows the system 150 as an architecture. The system includes a CPU 152, a storage/memory 154, an interface 156, a request receiving module 158, a risk assessment module 160, and query generating module 162. All of the components of the system 150 are connected or linked to each other (electronically and/or data), either directly or indirectly. In embodiments in which the system 150 is deployed separate from the user computer 120, the interface 156 is configured for exchanging packets with the network 110 and the user computer 120. For example, HTTP request messages sent by the user computer 120 via the interface 130 are received by the system 150 via the interface 156. In embodiments in which the system 150 is deployed as a web browser plug-in, the interface 156 may be one of the interfaces 130 of the user computer 120, and the processors of the CPU 152 may be implemented as part of the CPU 122.

The CPU 152 and the storage/memory 124, although shown as a single component for representative purposes, may be multiple components. The CPU 152 is formed of one or more processors, including microprocessors, for performing the system 150 functions, including executing the functionalities and operations of the modules 158, 160, 162, including the processes shown and described in the flow diagrams of FIGS. 4-6. The processors are, for example, conventional processors, such as those used in servers, computers, and other computerized devices. For example, the processors may include x86 Processors from AMD and Intel, Xeon® and Pentium® processors from Intel, as well as any combinations thereof.

The storage/memory 154 is any conventional storage media. The storage/memory 154 stores machine executable instructions for execution by the CPU 152, to perform the processes of the present embodiments, including instructions for executing the processes of FIGS. 4-6, detailed herein.

The modules 158, 160, 162 include software, software routines, code, code segments and the like, embodied, for example, in computer components, that may be installed on machines, such as the user computer 120, gateways, firewalls, proxy servers, and the like. Each of the modules 158, 160, 162 performs an action when a specified event occurs, as will be further detailed below. Note that although the modules 158, 160, 162 are shown as separate modules, the modules 158, 160, 162 may be combined such that the functions performed by the modules 158, 160, 162 are performed by a single module or distributed between combinations of the modules 158, 160, 162.

The request receiving module 158 is configured for receiving requests, from the web client 128, to retrieve a requested web resource (e.g., navigate to a requested web address). The requests are received from the web client 128 via the interface 156.

The risk assessment module 160 (which may also be referred to as a “reputation module”) is configured for assessing the risk associated with retrieving the requested web resource (i.e., determining the reputation of the web resource, e.g., the reputation of the web address that identifies the requested web resource). The risk assessment module 160 performs functions for assessing the risk associated with retrieving the web resource, where the risk includes the risk that the user computer 120 will be exposed to a phishing attack (by the web resource) if the web client 128 retrieves the requested web resource. The risk assessment module 160 assesses the risk by determining a reputation of the requested web resource, and by analogy a level of risk associated with the requested web resource.

In certain embodiments, the risk assessment module 160 determines the level of risk or reputation by assigning a metric, referred to herein as a “reputation score” or simply as a “score”, to the requested web resource, which quantifies the level of risk or reputation. In other words, the reputation score is indicative of the reputation of the requested web resource and by analogy is indicative of the amount of risk attributed to the requested web resource. By analogy, the reputation score can be considered as a likelihood or probabilistic metric that indicates the likelihood or probability that the requested web resource is a phishing web resource. In a non-limiting example, the reputation scores can take on values within a predefined numerical range, for example, 0-10, where reputation scores toward one end of the range are indicative of a low risk or strong reputation (small or low probability that the requested web resource is a phishing web resource), and reputation scores toward the opposite end of the range are indicative of a high risk or poor reputation (large or high probability that the requested web resource is a phishing web resource). The scoring range is a continuum, whereby a reputation score at one end of the scoring range is indicative of the lowest possible risk (strongest reputation) and a reputation score at the opposite end of the scoring range is indicative of the highest possible risk (poorest reputation), and reputation scores in between the ends of the scoring range occupy the continuum between low and high risk (strong and poor reputation). In one example, a reputation score of 0 is considered to be indicative of lowest possible risk (strongest reputation), and a reputation score of 10 is considered to be indicative of highest possible risk (poorest reputation). In principle, a web resource may be assigned any numerical reputation score within the continuum within the end values of the scoring range. Using the low-score-low-risk and high-score-high-risk example above, a reputation score of 5 may be indicative of a web resource having moderate risk (moderate reputation), whereas a reputation score of 4 may be indicative of a web resource having moderate-to-low-risk (moderate-to-strong reputation), whereas a reputation score of 6 may be indicative of a web resource having moderate-to-high-risk (moderate-to-poor reputation).

In certain embodiments, the risk assessment module 160 determines the level of risk or reputation, and in particular the assigned reputation score, by analyzing the requested web resource (or associated web address or domain) according to one or more of the following factors: one or more string characters or features of the web address associated with the requested web resource, one or more string characters or features of a domain name associated with the requested web resource, one or more input field of a requested web page (when the requested web resource is a web page), one or more string characters or features of the requested web resource, entropy of the words or characters in a domain name associated with the requested web resource.

In some embodiments, the risk assessment module 160 assigns a reputation score to a requested web resource by using artificial intelligence or other risk-ranking algorithms to identify anomalies in the requested web resource, or associated web address or domain. The following is a non-exhaustive list of anomalies (i.e., indicators) for which the risk assessment module 160 checks, and that are used by the risk assessment module 160 to assign a reputation score. These types of anomalies (i.e., indicators) can generally be used by the phishing detection components, such as the risk assessment module 160, to detect phishing attacks.
Recently registered domain,
Domain is not indexed in well-known search engines,
The web page or web site does not use a standard port,
Web pages or web sites using a public IP instead of a DNS name,
Lookalike characters in the web address from different alphabets when using internationalized domain names,
Use of lookalike characters in a web address or domain, for example, replacing the letter “o” of a legitimate domain name with the number “0” (“zero”), e.g., www.g00gle.com instead of www.google.com,
Insertion, deletion, and/or permutation of characters in the domain name, e.g., www.linkdin.com,
Addition of prefixes or suffixes to the web address or domain name, including keyword prefixes or suffixes such as, for example, “update”, “login”, and “secure”, e.g., www.applelogin.com,
A web address (URL) with which a web page is associated uses IP addresses instead of domain names,
A domain name inside of a web address (URL), e.g., https://galeriadasflores.com.br/user/www.linkedin.com/log/Linkedin/SignIn.php.,
Unsecured web pages and addresses, i.e., having prefix of HTTP and not HTTPS,
Web pages associated that include input fields having suspicious or sensitive words, e.g., input fields labeled as “username”, “password”, “account number”, “PIN”, etc.,
Unreasonably long domains,
Web addresses or domain names having extra characters, for example, multiple domain endings (e.g., www.paypal.com.com)
Unreasonably long host names,
Multiple periods in the web address (e.g., www.login.site.us.pay.pal.com), etc.,
Domains containing an unreasonable number of words,
Web pages or web sites that only use images (i.e., have no text),
Web pages or web sites that use embedded images instead of text,
Poor quality of web page or web site construction, for example, sites with multiple errors, sites with broken links, sites lacking a title, etc.

In other embodiments, the risk assessment module 160 determines the level of risk or reputation of a requested web resource based on risk/reputation information received from an external service that is linked to the network 110, and is exemplified in FIG. 1 as a reputation service 170. The reputation service 170 maintains frequently updated lists of reputations of domains and URLs, and in particular domains and URLs having moderate or poor reputation (e.g., suspicious domains and URLs). The reputation service 170 provides the updated lists to the system 150 via one or more feeds. The reputation service 170 may identify suspicious domains and URLs (for providing to the risk assessment module 160) by, for example, analyzing various parameters and features of web resources, such as, for example, URLs, web content, and the like. The reputation service 170 may generate heuristic models in order to identify characteristics of a URL by using various methods, including, but not limited to, generating one or more heuristics from URL similarly calculations, performing domain name probability evaluation, identifying a number of external links of a web page, analyzing an IP address associated with the web resource, and identifying the port number used by the web resource. The reputation service 170 may also obtain or extract data (including metadata) about web resources, in particular web pages and web sites. Specifically, the reputation service 170 may obtain web page ranking information, web site registration information, and web site category information. The reputation service 170 may obtain such information from a ranking service (linked to the reputation service 170 via the network 110) that maintains or is linked to one or more databases that store registered users or assignees of Internet resources (such as domain names and IP addresses). The information may be obtained from the ranking service by querying the one or more databases. Ranking services suitable for providing such information to the reputation service 170 are well known in the art, and are readily available. Non-limiting examples of such ranking services include those provided by WHOIS (iteration as of the filing of this document drafted by the Internet Society and documented by RFC 3912) and Google of Menlo Park Calif.

The reputation service 170 may provide the frequently updated lists to the risk assessment module 160 in an organized format, for example, categorized by reputation or level of risk. For example, the risk assessment module 160 may receive one or more list strictly containing URLs/domains classified by the reputation service 170 as being of low-risk (strong reputation), one or more list strictly containing URLs/domains classified by the reputation service 170 as being of low-to-moderate-risk (strong-to-moderate-reputation), one or more list strictly containing URLs/domains classified by the reputation service 170 as being of moderate-risk (moderate-reputation), one or more list strictly containing URLs/domains classified by the reputation service 170 as being of moderate-to-high-risk (moderate-to-poor reputation), and one or more list strictly containing URLs/domains classified by the reputation service 170 as being of high-risk (poor reputation).

Parenthetically, it should be clear that the above categorization of risk is strictly for example purposes, and the reputation and risk level of the URLs/domains can be broken down into a larger or smaller number of categories than the exemplary categories provided above.

In certain embodiments, in response to receiving (from the web client 128) a request to retrieve a web resource, the risk assessment module 160 may determine the reputation or level of risk associated with the requested web resource by assigning a numerical reputation score to the requested web resource, which quantifies the initial reputation or level of risk. In other embodiments, in response to receiving (from the web client 128) a request to retrieve a web resource, the risk assessment module 160 may determine the reputation or level of risk associated with the requested web resource by identifying the list(s) (received from the reputation service 170) that contains the URL/domain that corresponds to the requested web resource. For example, if a URL/domain of the requested web resource is present in a list containing “high risk” or “poor reputation” URLs/domains, the risk assessment module 160 determines that the level of risk attributed to the requested web resource is “high”, i.e., that the reputation of the requested web resource is “poor”. Optionally, the risk assessment module 160 may assign a numerical reputation score to the requested web resource based on the risk level assigned to the corresponding URL/domain by the reputation service 170. For example, if the requested web resource is identified by a URL that is present in a list containing low-to-moderate-risk (strong-to-moderate reputation) URLs/domains, the risk assessment module 160 may assign the web resource a numerical reputation score that is indicative of low-to-moderate-risk. Similarly, if the requested web resource is identified by a URL that is present in a list containing high-risk (poor reputation) URLs/domains, the risk assessment module 160 may assign the web resource a numerical reputation score that is indicative of high-risk.

In certain embodiments, the reputation service 170 may additionally provide the frequently updated lists to the risk assessment module 160 in a structured format, for example as a table or other data structure, so as to allow the risk assessment module 160 to use an efficient look-up approach in response to receiving (from the web client 128) a request to retrieve a web resource.

Parenthetically, the frequency at which the lists (provided by the reputation service 170 to the risk assessment module 160) are updated is preferably high enough so as to avoid, minimize (to the possible extent), or otherwise reduce instances in which a requested web resource in fact has a risk between moderate-risk and high-risk, but the URL/domain corresponding to the requested web resource does not appear in any of the lists of moderate risk URLs/domains, moderate-to-high-risk URLs/domains, or high-risk URLs/domains. In order to achieve such a high enough frequency, the risk assessment module 160 may be linked to more than one such reputation service 170, and may aggregate or combine lists obtained from each such reputation service.

In certain embodiments, the risk assessment module 160 is further configured to perform various threshold tests by evaluating the determined risk level (i.e., reputation of the web resource) against various threshold criteria. In certain embodiments, the risk assessment module 160 evaluates the initial level of risk against a predetermined level of risk, and by analogy, evaluates the reputation against a predetermined reputation level. The evaluation may include evaluating reputation scores (indicative of risk) against various threshold criteria. In a particular non-limiting implementation, the risk assessment module 160 compares an obtained risk level or reputation score against a first threshold criterion to determine if the risk level or reputation score satisfies the first threshold criterion which indicates that the requested web resource poses a risk to the user computer 120. If, as a result of the comparison with the first threshold criterion, the risk assessment module 160 determines that the requested web resource poses little to no risk, the system 150 may provide an instruction to allow the request to propagate through the network 110 to the web server 140 so as to allow the web client 128 to retrieve the web resource, thereby rendering the web resource web content at the web client 128. Using the scoring system example described above in which a low reputation score corresponds to strong reputation and a high reputation score corresponds to poor reputation, the first threshold criterion may be a reputation score of 5, such that if the reputation score is less than or equal to 5, the risk assessment module 160 determines that the requested web resource poses moderate to no risk, and allows the request to propagate through the network 110 to the web server 140 so as to allow the web client 128 to the web resource, thereby rendering the web resource web content at the web client 128.

If the risk level or reputation score does not satisfy the first threshold criterion, the risk assessment module 160 compares the risk level or reputation score against a second threshold criterion to determine if the to determine if the risk level or reputation score satisfies the second threshold criterion which indicates that the requested web resource poses a significant risk to the user computer 120. If, as a result of the comparison with the second threshold criterion, the risk assessment module 160 determines that the requested web resource poses a significant risk, the system 150 may provide an instruction to block the request to retrieve the web resource (e.g., block the request to open the requested web page). Using the scoring system example described above, the second threshold criterion may be a reputation score of 8, such that if the reputation score is above 8, the risk assessment module 160 determines that the requested web resource poses significant risk.

If the risk level or reputation score does not satisfy the first and second threshold criteria, the risk assessment module 160 determines that additional information is needed to assess the risk posed by the requested web resource. The system 150 attempts to gather this additional information by prompting the user of the user computer 120 for feedback regarding the requested web resource in order to glean information pertaining to the reputation/risk of the web resource from user responses to the prompts. Prior to prompting the user, the risk assessment module 160 actuates (i.e., commands) the query generating module 162 to generate one or more query that corresponds to the requested web resource. The system 150 then prompts the user of the user computer 120 to respond to the one or more query. For example, using the scoring system example described above, the system 150 generates the one or more query and prompts the user if the reputation score is greater than 5 but less than or equal to 8. As a further example, the system 150 may generate the one or more query and prompt the user if the URL/domain of the web resource is present in a list strictly containing URLs/domains categorized as being of a particular risk level (e.g., high-risk or moderate-to-high-risk).

It is noted that the above-mentioned threshold tests can be performed in any order, or can be performed in parallel. As should be apparent, the risk assessment module 160 may simply check whether the reputation score falls within a particular range (for example, between 5 (inclusive) and 8 (exclusive) using the scoring system example described above) in order to determine whether or not to generate queries and prompt the user to respond to the queries. Furthermore, in certain embodiments, such as embodiments in which the reputation or level of risk is determined based on information provided by the reputation service 170, a single threshold test may be performed.

It has been found that methods which rely strictly on machine learning and artificial intelligence algorithms to perform analysis of web addresses and web pages to determine risk (reputation) have shortcomings, most notably, the inability to replicate the human instinct (colloquially “gut feel”) in a computer. The prompting of the user of the user computer 120 to respond to the one or more query enables the system 150 to supplement conventional computer analysis with data gleaned from human instinctual responses. Furthermore, in prompting the user of the user computer 120 to respond to one or more query, the user's attention is focused on details of the requested web resource that may seem, at the user's first glance, innocuous to the user computer 120, but are in fact revealing of the risk associated with retrieving the web resource (e.g., opening/connecting to a web page). By bringing the risk to the user's attention, in the form of one or more query, and by receiving feedback to the one or more query from the user, the system 150 can more reliably determine whether the web resource that the user intends to retrieve is a phishing web resource (e.g., the web page to which the user intends to navigate is a phishing web page), and can then allow the user to decide whether or not to accept the risk and proceed to retrieve the intended web resource (e.g., open the intended web page).

The query generating module 162 generates, preferably dynamically, the one or more query in accordance with the risk level and/or reputation score and/or the anomalies identified by the risk assessment module 160. In certain embodiments, the number of queries generated by the query generating module 162 corresponds to the risk level and/or reputation score assigned to the requested web resource. For example, if the requested web resource has a lower risk level or a reputation score indicative of lower risk (e.g., a reputation score at or near the lower end of the threshold range, e.g., a reputation score less than 6), a correspondingly small number of queries may be generated. Similarly, if the requested web resource has a higher risk level or a reputation score indicative of a higher risk (e.g., a reputation score at or near the upper end of the threshold range, e.g., a reputation score greater than or equal to 7), a correspondingly large number of queries may be generated. In certain embodiments, the query generating module 162 generates at least one query for each anomaly identified by the risk assessment module 160.

The system 150 (via, for example, the query generating module 162 or the risk assessment module 160) may inform the user of the user computer 120 of the poor reputation (high risk) of the requested web resource by presenting the level of risk and/or the reputation score to the user, and may then inquire as to whether the user of the user computer 120 wants to participate in a feedback process, whereby the system 150 prompts the user to respond to one or more query. If the user chooses to participate, the system 150 prompts the user of the user computer 120 to respond to the generated one or more query. As should be apparent, it may be practical for the system 150 to generate the one or more query only after the user responds in the affirmative to the request to participate in the feedback process. In certain embodiments, the informing of the user of the level of risk and/or the reputation score, inquiring as to whether the user wants to participate in the feedback process, and the prompting of the user to respond to the one or more query, are performed by sending the reputation information (e.g., level of risk, reputation score), participation inquiry, and the generated one or more query to the user computer 120 such that they are visually displayed to the user on a display (e.g., screen, monitor, etc.) of the user computer 120. The reputation information, participation inquiry, and one or more query may be provided to the user of the user computer 120 as a pop-up via the web client 128, a web page injection display, or any other suitable method.

The participation inquiry and prompts are interactive in nature and provide an opportunity for the user of the user computer 120 to provide feedback to the system 150. In a particularly preferred but non-limiting implementation, the prompts take the form of yes/no type questions that the user of the user computer 120 may respond to by responsive input via one or more input devices or interfaces (e.g., keyboard, mouse, interactive touchscreen, voice command etc.) connected to the user computer 120.

The generated queries are in the form of questions, which may include questions pertaining to, for example, the source of a web address hyperlink, the true domain that will be connected to if a requested web page is opened, whether or not the web address associated with the requested web resource uses a secured connection (HTTPS), the geographic location of the web server hosting the requested web resource, and the like. In certain embodiments, the system 150 may have access to, or may store (in a memory, such as the storage/memory 154) one or more query template, which are sorted and stored according to one or more characteristic or feature, such as type of identified anomaly and level of risk. In response to a command to dynamically generate the one or more query, the query generating module 160 may, for example, retrieve a suitable template (or templates) according to the identified anomaly and level of risk, and fill in the appropriate information in the template with information corresponding to the particular requested web resource.

For sake of illustration, the following are non-limiting examples of the types of queries that user of the user computer 120 may be prompted to respond to by the system 150, where text in square brackets may be replaced with information corresponding to the particular requested web resource:
Did you open a hyperlink in an e-mail you received from an unknown source?
The web site or web page you are trying to open will connect you to the domain express.daddi99.com and navigate to the web address http://express.dadi99.com/paypal/account/signin.aspx. Are you sure you want to connect to this domain and navigate to this web address?
The requested web page or web site does not use a secured (HTTPS) connection. Do you want to connect to the requested web page or web site?
The requested web site is hosted in [name of country]. Do you want to connect to the requested web site?
Did you intend to visit a web site hosted in [name of country]?
Did you know that the web site you are attempting to visit is hosted in [name of country]?
Did you know that the web site you are attempting to visit was established [number of days ago]?
Did you know that the web site you are attempting to visit has typographical errors in its URL and/or domain name?
Did you know that the web site you are attempting to visit has [specific amount] of entropy in its URL?
Did you intend to visit a web site of [specific category (e.g., banking, pornography, etc.)]?

As should be clear, the domains and URLs used in the example queries above are strictly for example purposes.

The user responses to the generated queries are sent to the system 150 (by, for example, the web client 128) and are received by the risk assessment module 160 (via, for example, the interface 156). The user responses to each query are used, by the risk assessment module 160, to update the initial risk level (reputation) and/or reputation score in order to generate an updated risk level (reputation) and/or reputation score. In embodiments in which the risk assessment module 160 assigns a numerical reputation score to the web resource that is indicative of the risk level associated with the web resource, the updated reputation score is indicative of the updated risk level (reputation) associated with retrieving the requested web resource (i.e., navigating to the web address that identifies the requested web resource, e.g., opening a requested web page,). In cases where the user is prompted to respond to multiple queries, the user responses to the queries may be aggregated and used to modify the initial risk level/reputation score to generate an updated risk level (reputation) or reputation score.

The risk assessment module 160 may then evaluate the updated risk level (reputation) or reputation score against at least one threshold criteria. In a particularly preferred but non-limiting implementation, the risk assessment module 160 compares the updated risk level (reputation) or reputation score against the second threshold criterion to determine how to handle the request to retrieve the requested web resource. If the updated risk level (reputation) or reputation score satisfies the threshold criterion, the system 150 blocks the request to retrieve the requested web resource. The system 150 may also add the requested web resource, the web address associated with the requested web resource, and/or the domain associated with the requested web resource to a black list. If the updated risk level (reputation) or reputation score does not satisfy the threshold criterion, the system 150 allows the request to propagate through the network 110 to the web server 140 so as to allow the web client 128 to retrieve the web resource, thereby rendering the web resource web content at the web client 128. Using the scoring system example described above and the second threshold criterion reputation score of 8, if the updated reputation score is above 8, the risk assessment module 160 determines that the requested web address poses significant risk such that the system 150 blocks the request to retrieve the requested web resource (and optionally adds the web page/site, web address, and/or domain to a black list). If the updated reputation score is less than or equal to 8, the system 150 allows the request to propagate through the network 110 to the web server 140 so as to allow the web client 128 to retrieve the web resource, thereby rendering the web resource web content at the web client 128.

Attention is now directed to FIG. 4 which shows a flow diagram detailing a computer-implemented process 400 in accordance with embodiments of the disclosed subject matter. This computer-implemented process includes an algorithm for detecting phishing web resources based on user feedback, in particular determining a reputation of a requested web resource (e.g., web page). Reference is also made to the elements shown in FIGS. 1-3. The process and sub-processes of FIG. 4 are computerized processes performed by the system 150 including, for example, the CPU 154 (or the CPU 122 in embodiments in which the system 150 is deployed as a plug-in of the web browser 128) and associated components, such as the modules 158, 160, 162. The aforementioned processes and sub-processes are preferably performed automatically, and are preferably performed in real-time.

The process 400 begins at step 402 where the system 150, and more specifically the request receiving module 158, receives (from the web client 128) a request to retrieve a requested web resource. The request is addressed to the web server 140 (i.e., is intended for the web server 140), and the system 150 intercepts the request before it reaches the web server 140. As discussed, the request may be received by the system 150 via the interface 156. In a particularly relevant application, the web resource is a web page, and the system 150, at step 402, receives a request from the web client 128 to open the web page.

At step 404, in response to the received request, the system 150 determines an initial reputation of the requested web resource. The initial reputation may be the reputation of the web address (URL) that identifies a web page or web site to which the user has requested to navigate. In certain embodiments, the risk assessment module 160 may determine the initial reputation by assigning to the requested web resource a quantitative initial numerical reputation score by way of analyzing characteristics or features of one or more of: the web resource, the web address that identifies the requested web resource, or the domain to which the requested web resource belongs. The analysis performed by the risk assessment module 160 identifies anomalies in one or more of: the requested web resource, the associated the web address, or the associated domain name. In other embodiments, the risk assessment module 160 may determine the initial reputation by checking the one or more list provided by the reputation service 170 for the presence of a URL that identifies the requested web resource, or for the presence of a domain associated with the requested web resource (e.g., the domain of the requested website). The reputation service 170 may perform functions similar to those performed by the risk assessment module 160 in order to identify anomalies in the requested web resource, or associated web address or domain. Optionally, the risk assessment module 160 may assign a numerical reputation score that quantifies the level of risk obtained from the aforementioned one or more list.

The process 400 then moves to step 406, where the risk assessment module 160 evaluates the initial reputation to determine if the reputation of the requested web resource is sufficient to allow the user to retrieve the requested web resource (e.g., navigate to the requested web address). If the risk assessment module 160 determines that the reputation is of a sufficient level, the process 400 moves to step 408, where the system 150 determines that the requested web resource poses little to no risk (threat), and the system 150 provides an instruction to allow the request to propagate through the network 110 to the web server 140 so as to allow the web client 128 to retrieve the web resource, thereby rendering the web resource web content at the web client 128. If, however, the risk assessment module 160 determines that the reputation is not of a sufficient level, the system 150 determines that the web resource poses some significant level of risk, and the process 400 moves to step 410. The determination may be effectuated by comparing the reputation score with a threshold value. For example, in implementations in which a low score is indicative of strong reputation, if the reputation score is below a predetermined threshold value (set by the system 150), the process 400 moves to step 408, whereas if the reputation score is above the predetermined threshold value, the process 400 moves to step 410.

At step 410, the system 150, and in particular the query generating module 162, generates one or more query that correspond to the requested web resource. As discussed above, the query generating module 162 may generate the one or more query in accordance with the reputation (score) and/or the anomalies identified by the risk assessment module 160 (or the reputation service 170). For example, a poorer reputation (indicative of a higher relative risk) may produce a larger number of queries as compared to a stronger reputation (indicative of a lower relative risk). Likewise, a large number of anomalies detected by the risk assessment module 160 or the reputation service 170 may produce a large number of queries of different, with each respective anomaly corresponding to a different respective query.

At step 412, the system 150 prompts the user of the user computer 120 to respond to the one or more query generated in step 410. Step 412 may optionally include providing the user with the initial reputation, and asking if the user wants to participate in a feedback process by responding to one or more query. The prompting may be performed by sending the initial reputation, participation request, and generated one or more query to the user computer 120 such that they are visually displayed to the user on a display (e.g., screen, monitor, etc.) of the user computer 120. The reputation information, participation inquiry, and one or more query may be provided to the user of the user computer 120 as a pop-up via the web client 128, a web page injection display, or any other suitable method. As discussed above, the user of the user computer 120 responds to each of the prompts via, for example, one or more input devices or interfaces (e.g., keyboard, mouse, interactive touchscreen, voice command etc.) connected to the user computer 120. The user responses are sent to the system 150 via, for example, the web client 128, and are received by the risk assessment module 160 (via, for example, the interface 156) at step 414.

At step 416, the risk assessment module 162 updates the initial reputation, e.g., the reputation score (determined in step 404) to generate an updated reputation, based on the initial reputation and the responses received at step 414. In certain embodiments, the initial reputation may be updated by re-calculating the reputation score by incorporating information gleaned from the user responses. For example, if the responses indicate that the user intends to retrieve the web resource despite the prompts presented at step 412, the risk assessment module 160 may generate an updated reputation score that reflects a stronger reputation than initially indicated by the initial reputation score. On the other hand, if the user responses indicate that the user does not intend to retrieve the web resource, the risk assessment module 160 may generate an updated reputation score that reflects a poorer reputation than initially indicated by the initial reputation score.

The process 400 then moves to step 418, where the risk assessment module 160 evaluates the updated reputation to determine if the reputation of the requested web resource is now sufficient to allow the user to retrieve the requested web resource (e.g., navigate to the requested web address). If the risk assessment module 160 determines that the updated reputation is of a sufficient level, the process 400 moves to step 408. If, however, the risk assessment module 160 determines that the updated reputation is still not of a sufficient level, the system 150 determines that the web resource still poses some significant level of risk, and the process 400 moves to step 420. As in step 406, the determination at step 418 may be effectuated by comparing the updated reputation score with a threshold value.

At step 420, the system 150, via, for example, the query generating module 162, prompts the user of the user computer 120 with a final prompt, indicating the updated reputation and associated risk factor of retrieving the requested web resource, and inquiring as to whether the user would like to continue to retrieve the requested web resource despite the provided warning. If the user responds to the prompt in the affirmative, the process 400 may then move to step 408. If, however, the user responds to the prompt in the negative (i.e., the user does not wish to retrieve the requested web resource), the process 400 may then move to step 422 (and optionally step 424).

At step 422, the system 150 provides an instruction to block the request to retrieve the requested web resource. The instruction to block the request may be effectuated by the system 150 preventing the request from reaching the web server 140, for example by refraining from forwarding the request to the web server 140 via the interface 156. The instruction to block the request may alternatively or additionally be effectuated by forwarding the request to the web server 140 so as to receive (at the system 150) the web content (corresponding to the requested web resource) from the web server 140, but refraining from forwarding (by the system 150) the web content to the web client 128.

At step 424, which may be executed subsequent to step 422 or in parallel with step 422, the system 150 adds the requested web resource, the web address associated with the requested web resource, and/or the domain associated with the requested web resource to a black list.

Note that step 420 may be optionally performed, and the process 400 may move directly to step 422 (and optionally step 424) if the risk assessment module 160 determines (at step 418) that the updated reputation is still not of a sufficient level.

It is noted that steps 414-418 may be functionally executed as a single step, or as combinations of steps executed in parallel, by the risk assessment module 160.

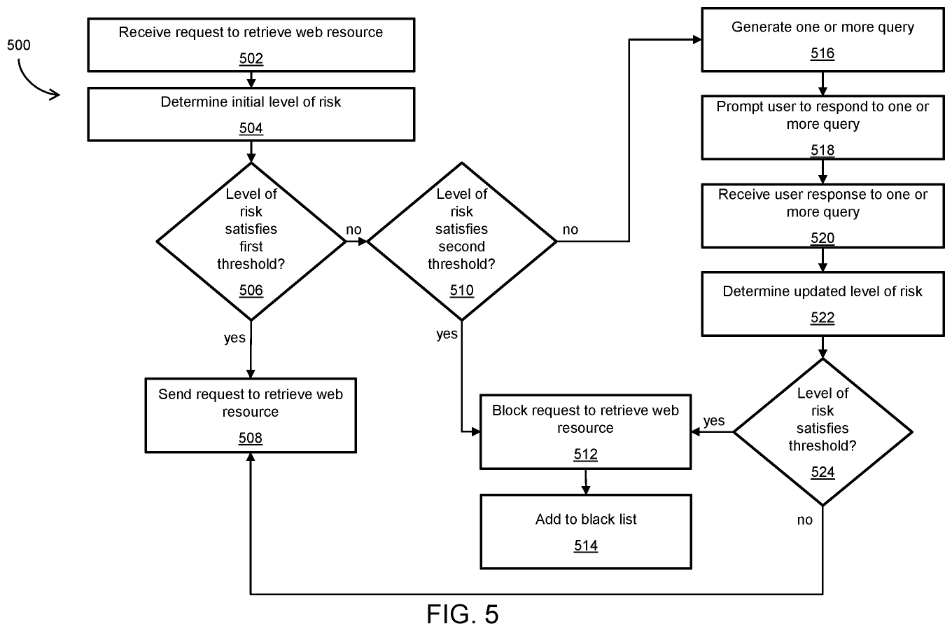

Attention is now directed to FIG. 5 which shows a flow diagram detailing a computer-implemented process 500 in accordance with embodiments of the disclosed subject matter. This computer-implemented process includes an algorithm for detecting phishing web resources based on user feedback, in particular determining a level of risk associated with retrieving a web resource that is suspected of being a phishing web resource. Reference is also made to the elements shown in FIGS. 1-3. The process and sub-processes of FIG. 5 are computerized processes performed by the system 150 including, for example, the CPU 154 (or the CPU 122 in embodiments in which the system 150 is deployed as a plug-in of the web browser 128) and associated components, such as the modules 158, 160, 162. The aforementioned processes and sub-processes are preferably performed automatically, and are preferably performed in real-time.

It is noted that the process 500 is generally similar to the process 400, but differs in that the process 500 explicitly describes a two-tiered initial risk/reputation evaluation step, whereby as a result the system 150 provides options to: 1) immediately allow the user to retrieve the requested web resource, 2) immediately block a requested web resource (and black list associated web addresses and/or domains), and 3) request user feedback to further evaluate risk/reputation.

The process 500 begins at step 502 where the system 150, and more specifically the request receiving module 158, receives (from the web client 128) a request to retrieve a requested web resource. The request is addressed to the web server 140 (i.e., is intended for the web server 140), and the system 150 intercepts the request before it reaches the web server 140. As discussed, the request may be received by the system 150 via the interface 156. In a particularly relevant application, the web resource is a web page, and the system 150, at step 502, receives a request from the web client 128 to open the web page.

At step 504, in response to the received request, the system 150 determines an initial level of risk associated with the requested web resource. In certain embodiments, the risk assessment module 160 may determine the initial level of risk by assigning to the requested web resource a quantitative initial numerical reputation score by way of analyzing characteristics or features of one or more of: the web resource, the web address that identifies the requested web resource, or the domain to which the requested web resource belongs. The analysis performed by the risk assessment module 160 identifies anomalies in one or more of: the requested web resource, the associated the web address, or the associated domain name. In other embodiments, the risk assessment module 160 may determine the initial level of risk by checking the one or more list provided by the reputation service 170 for the presence of a URL that identifies the requested web resource, or for the presence of a domain associated with the requested web resource (e.g., the domain of the requested website). The reputation service 170 may perform functions similar to those performed by the risk assessment module 160 in order to identify anomalies in the requested web resource, or associated web address or domain. Optionally, the risk assessment module 160 may assign a numerical reputation score that quantifies the level of risk obtained from the aforementioned one or more list.

The process 500 then moves to step 506, where the risk assessment module 160 evaluates the initial level of risk against at least one threshold criterion to determine if the web resources poses a risk that is within a particular range, for example moderate-to-high-risk (i.e., not strictly high risk, and not strictly moderate risk or low risk). By analogy, at step 506 the risk assessment module 160 evaluates the initial reputation of the requested web resource against a reputation level (preferably predetermined reputation level) to determine if the initial reputation is of a sufficient level. In certain embodiments, the numerical reputation score assigned to the web resource, that is indicative of the level of risk associated with the web resource, is evaluated against a series of threshold criteria. In other embodiments, the at least one threshold criterion is a predetermined level of risk. For example, the URL/domain of the requested web resource may be checked for presence in one or more list, and the risk level associated with the checked list may be checked against a predefined risk level. The checked list may strictly contain URLs/domains which are categorized as having a common particular reputation or level of risk, and the reputation or risk level associated with the contents of the checked list may be checked against a predetermined reputation level of risk to determine whether the reputation associated with the contents of the checked list is of a sufficient level, or whether the risk level associated with the contents of the checked list is greater than or equal to a predetermined level of risk.

If the initial level of risk satisfies the threshold criterion, the process 500 moves from step 506 to step 508, where the system 150 determines that the requested web resource poses little to no risk (threat), and the system 150 provides an instruction to allow the request to propagate through the network 110 to the web server 140 so as to allow the web client 128 to retrieve the web resource, thereby rendering the web resource web content at the web client 128. Specifically, if the initial risk level or reputation score satisfies the first threshold criterion (e.g., a reputation score indicative of a relatively low risk (relatively strong reputation), such as less than 5 in the exemplary scoring system previously described, or the URL/domain of the web resource is present in a list categorized as low-risk (strong reputation)), the request message is allowed (by the system 150) to reach the web server 140. Furthermore, the web content corresponding to the requested web resource (and in certain instances the response messages from the web server 140) is allowed (by the system 150) to reach the web client 128. In such cases, the system 150 may act as a network relay system, which receives the web content (corresponding to the requested web resource) from the web server 140, and relays the web content to the web client 128 (via, for example, the interfaces 156 and 130).

If the initial level of risk does not satisfy the threshold criterion (for example if the initial reputation score is above a certain numerical value, or if the URL/domain of the web resource is present in a list categorized as above a particular level of risk, e.g., above low-risk), the process 500 moves from step 506 to step 510, where the risk assessment module 160 compares the initial risk level or reputation score to a second threshold criterion, in order to determine whether to block the requested web resource, or whether to gather additional information by prompting the user of the user computer 120 for feedback regarding the requested web resource. In embodiments in which the risk assessment module 160 assigns an initial numerical reputation score indicative of the level of risk, the risk assessment module 160 may compare the initial reputation score to the second threshold criterion, by, for example, checking whether the initial reputation score is above a particular numerical value (for example a reputation score of 8 in the exemplary scoring system previously described). In embodiments in which the risk assessment module 160 receives information from the reputation service 170, the system 150 may check whether the URL/domain of the requested web resource is present in a particular list, and the risk level associated with that list may be checked against a predefined risk level.

If the initial risk level or reputation score satisfies the second threshold criterion (e.g., if the reputation score is indicative of relatively high risk (poor reputation), e.g., greater than 8 in the exemplary scoring system previously described, or if the URL/domain of the web resource is present in a list categorized as high-risk), the process 500 moves from step 510 to step 512, where the system 150 provides an instruction to block the request to retrieve the requested web resource. The instruction to block the request may be effectuated by the system 150 preventing the request from reaching the web server 140, for example by refraining from forwarding the request to the web server 140 via the interface 156. The instruction to block the request may alternatively or additionally be effectuated by forwarding the request to the web server 140 so as to receive (at the system 150) the web content (corresponding to the requested web resource) from the web server 140, but refraining from forwarding (by the system 150) the web content to the web client 128.

Subsequent to, or in parallel with, step 512, the system 150 may perform step 514, in which the system adds the requested web resource, the web address associated with the requested web resource, and/or the domain associated with the requested web resource to a black list.

If, at step 510, the initial risk level or reputation score does not satisfy the second threshold criterion (e.g., if the initial reputation score is below a particular numerical value (e.g., 8), or if the URL/domain of the web resource is absent from all lists categorized as high-risk, but is present in a list categorized as moderate-to-high risk), the process 500 moves to step 516, where the risk assessment module 160 determines that the requested web resource does not pose a significant enough risk (or threat) to warrant immediately blocking the request (as in step 512), but at the same time poses some amount of risk that the system 150 does not immediately allow the web content to be received at the web client 128 (as in step 508). In this scenario, in which the reputation score is indicative of an intermediate risk between moderate-risk and high-risk (intermediate reputation between poor reputation and moderate reputation), or in which the initial risk level (based on the lists provided by the reputation service 170) is indicative of an intermediate risk level between moderate-risk and high-risk (i.e., having a risk level that is neither low enough to warrant immediate retrieval of the web resource, nor high enough to warrant immediate blocking of the request), the system 150 performs additional steps, namely steps 516-522 in order to gather additional information about the web resource by prompting the user of the user computer 120 for feedback regarding the requested web resource.

Parenthetically, steps 506 and 510 may be functionally combined into a single step. For example, at step 506 the system 150 may determine that the initial reputation is not of a predetermined sufficient reputation level (i.e., that the initial reputation is too poor), such that the process 500 jumps directly to step 516. In another example, if at step 506, the system 150 determines that the URL/domain associated with the requested web resource appears in an obtained list containing moderate-to-high-risk (poor-to-moderate reputation) URLs/domains (or possibly high-risk (poor reputation) URLs/domains), the process 500 may jump directly to step 516. For example, if the requested web resource is associated with a URL/domain that is present in a list categorized as strictly containing URLs/domains of a particular level of risk (reputation) that is greater than a first predetermined level of risk but less than a second predetermined level of risk (i.e., above one reputation level but below another reputation level), the process 500 may move from step 506 to step 516. For example, the checked list may strictly contain URLs/domains which are categorized as having a common particular level of risk (e.g., moderate-to-high-risk or high-risk, i.e., poor-to-moderate reputation or poor reputation), and the risk (reputation) level associated with the contents of the checked list may be checked against predetermined levels of risk (reputation) to determine whether the risk (reputation) level associated with the contents of the checked list is greater than or equal to a first predetermined level of risk or reputation level (e.g., moderate risk, moderate reputation), but less than a second predetermined level of risk or reputation level (e.g., high-risk, poor reputation). As such, for example, if the requested web resource is associated with a URL/domain that is present in a list categorized as strictly containing URLs/domains of moderate-to-high-risk or possibly high-risk (poor-to-moderate reputation or possibly poor reputation), and the first predetermined level of risk or reputation level is set to moderate-risk or moderate reputation, and the second predetermined level of risk or reputation level is set to high-risk or poor reputation, the system 150 takes steps to prompt the user for feedback, as described in steps 516-522.

In yet another example, if at step 506 the system 150 determines that the initial numerical reputation score falls in a particular range corresponding to reputation scores indicative of moderate-to-high-risk (poor-to-moderate reputation) web resources (or possibly high-risk, poor reputation web resources), the process 500 may jump directly to step 516.

At step 516, the system 150, and in particular the query generating module 162, generates one or more query that correspond to the requested web resource. As discussed above, the query generating module 162 may generate the one or more query in accordance with the risk level or reputation score and/or the anomalies identified by the risk assessment module 160. For example, a higher relative risk level or a reputation score that is indicative of a higher relative risk (poorer reputation) may produce a larger number of queries as compared to a lower relative risk or a reputation score indicative of a lower relative risk. Likewise, a large number of anomalies detected by the risk assessment module 160 or the reputation service 170 may produce a large number of queries of different variety, with each respective anomaly generating a different respective query.

At step 518, the system 150 prompts the user of the user computer 120 to respond to the one or more query generated in step 516. Step 518 may optionally include providing the user with the initial risk level or reputation, and asking if the user wants to participate in a feedback process by responding to one or more query. The prompting may be performed by sending the initial risk level or reputation, participation request, and generated one or more query to the user computer 120 such that they are visually displayed to the user on a display (e.g., screen, monitor, etc.) of the user computer 120. The reputation information, participation inquiry, and one or more query may be provided to the user of the user computer 120 as a pop-up via the web client 128, a web page injection display, or any other suitable method. As discussed above, the user of the user computer 120 responds to each of the prompts via, for example, one or more input devices or interfaces (e.g., keyboard, mouse, interactive touchscreen, voice command etc.) connected to the user computer 120. The user responses are sent to the system 150 via, for example, the web client 128, and are received by the risk assessment module 160 (via, for example, the interface 156) at step 520.

At step 522, the risk assessment module 162 updates the initial level of risk (reputation) or reputation score (determined in step 504) to generate an updated level of risk (reputation) or an updated reputation score, based on the initial level of risk (reputation) and the responses received at step 520. In certain embodiments, the initial reputation score may be updated by re-calculating the reputation score by incorporating information gleaned from the user responses. For example, if the responses indicate that the user intends to retrieve the web resource despite the prompts presented at step 518, the risk assessment module 160 may generate an updated reputation score that reflects a lower risk than initially indicated by the initial reputation score. On the other hand, if the user responses indicate that the user does not intend to retrieve the web resource, the risk assessment module 160 may generate an updated reputation score that reflects a higher risk than initially indicated by the initial reputation score.

The updated risk level (reputation) or reputation score is compared with a threshold criterion at step 524. In a particularly preferred but non-limiting implementation, the threshold criterion at step 524 is the same threshold evaluated at step 510. If, at step 524, the updated risk level (reputation) or reputation score satisfies the threshold criterion (for example if the updated reputation score is above a particular numerical value, or if the URL/domain of the requested web resource is present in a list categorized as high-risk (or moderate-to-high-risk)), the process 500 moves from step 524 to steps 512 and 514. If, at step 524, the updated risk level (reputation) or reputation score does not satisfy the threshold criterion (for example, if the updated reputation score is below the particular numerical value, or if the URL/domain of the requested web resource is absent from lists categorized as high-risk (or moderate-to-high-risk)), the process 500 optionally moves from step 524 to step 508, wherein the system 150 provides an instruction to allow the request to propagate through the network 110 to the web server 140 so as to allow the web client 128 to retrieve the web resource, thereby rendering the web resource web content at the web client 128.

Optionally, if, at step 524, the updated risk level (reputation) or reputation score satisfies the threshold criterion, the system 150 may prompt the user of the user computer 120 with a final prompt. The final prompt may indicate the updated risk level or reputation and associated risk factor of retrieving the requested web resource, and inquire as to whether the user would like to continue to retrieve the requested web resource despite the provided warning. If the user responds to the prompt in the affirmative, the process 500 may move to step 508. If, however, the user responds to the prompt in the negative (i.e., the user does not wish to retrieve the requested web resource), the process 500 may then move to step 512 (and optionally step 514).

It is noted that steps 520-524 may be functionally executed as a single step, or as combinations of steps executed in parallel, by the risk assessment module 160.

The initial risk levels and/or reputation scores, as well as the updated risk levels (reputation) and/or reputation scores, are preferably stored in a memory that is accessible by the risk assessment module 160, such as the storage/memory 154.

The functions performed by the system 150, exemplarily described in the processes 400 and 500 and with reference to FIGS. 4 and 5, respectively, act to reduce the number of missed detection and false alarms with respect to identification of phishing web pages or sites. In particular, through execution of the steps of the processes 400 and 500, the system 150 reduces the number of missed detections, which is generally defined as the number of occurrences that the system 150 allows the user of the user computer 120 to retrieve a web resource (based on the initial risk level/reputation score or updated risk level/reputation score) that turns out to be a phishing web resource. Similarly, through execution of the steps of the processes 400 and 500, the system 150 reduces the number of false alarms, which is generally defined as the number of occurrences that the system 150 initially flags a web resource as a phishing web resource, but allows the user of the user computer 120 to retrieve the web resource (based on the updated risk level or reputation score), and the retrieved web resource turns out to be an innocuous web resource.

The system 150 may perform additional functions to further reduce the number of missed detections and false alarms for other users linked to the system 150. For example, after execution of step 408 or 508, the system 150 may log and analyze data exchanged between the web client 128 and the web server 140 to extract information that is indicative that the web resource is indeed a phishing web resource. The system 150 may use the data and the extracted information to update the initial risk level/reputation score or updated risk level/reputation score. For example, if the initial risk level or reputation score is low enough such that the system executes step 408 or 508 in immediate response to step 406 or 506, but the requested web resource turns out to be a phishing web resource (i.e., a missed detection), the data and the extracted information can be used by the risk assessment module 160 to generate a new risk level or reputation score that is higher than the initial risk level or reputation score. The system 150 may then add at least one of: the web resource, associated domain name, or associated web address to a black list (as in step 424 or 514). Similarly, if the updated risk level (reputation) or reputation score is lowered as compared to the initial risk level or reputation score so as to allow the user to retrieve the requested web resource (i.e., execution of step 408 or 508 in immediate response to the execution of steps 410-418 or 516-524), but the requested web resource turns out to be a phishing web resource (i.e., a missed detection), the data and the extracted information can be used by the risk assessment module 160 to generate a new risk level or reputation score that is higher than the updated risk level or reputation score of step 416 or 522. The system 150 may then add at least one of: the web resource, associated domain name, or associated web address to a black list (as in step 424 or 514). The new risk levels/reputation scores are preferably stored, together with the initial risk levels/reputation scores and updated risk levels/reputation scores, in a memory that is accessible by the risk assessment module 160, such as the storage/memory 154.

Likewise, if the initial risk level or reputation score (in step 504) or the updated risk level (reputation) or reputation score (in step 416 or 522) is high enough such that the system 150 blocks the request such that the user is denied retrieving the web resource, the system 150 may monitor at least one of the requested web resource, associated domain, or associated web address. The monitoring may include analyzing network traffic data to and from the web server associated with the web page to glean information indicative of whether the web resource is a phishing web resource, and may be performed by the system 150 or an external service, such as the reputation service 170. If, as a result of this monitoring, the system 150 determines that the web resource is in fact innocuous or questionably suspicious, the system 150 may reduce the risk level and associated reputation score, and may take further action, such as, for example, removing the web resource, and/or associated domain name, and/or associated web address from a black list.

As briefly mentioned, the reputation analysis/risk assessment executed by the risk assessment module 160 is performed by determining an initial reputation or level of risk (associated with a requested web resource), and applying at least one rule to the initial reputation or level of risk so as to check whether the initial reputation or level of risk satisfies predetermined reputation or risk threshold. The application of the at least one rule may depend on the method of obtaining the initial reputation or level of risk. In embodiments in which the risk assessment module 160 obtains the initial reputation or level of risk by performing analyses to identify anomalies in the requested web resource (for example by checking for anomalies in one or more of the web address that identifies the requested web resource, the domain name associated with the requested web resource, etc.), the at least one rule may be applied by assigning an initial reputation score (indicative of the initial level of risk associated with the requested web resource), and evaluating the initial reputation score one or more numerical thresholds, whereby user feedback to query prompts is requested if the reputation score falls within a particular numerical range or satisfies a particular threshold reputation score. In embodiments in which the risk assessment module 160 receives lists of URLs/domains categorized according to risk level or reputation from the reputation service 170, the at least one rule is applied by searching/checking for the presence of the web address (URL) or domain associated with the requested web resource in the received lists, and evaluating the risk level or reputation of the list in which the web address and/or domain is found against a predetermined risk/reputation level (i.e., a threshold level), whereby user feedback to query prompts is requested if the web address or domain associated with the requested web resource is present in a list having a particular level of risk or reputation.

Although embodiments of the present invention have thus far been described with reference to a system that is linked to a single user computer, the embodiments of the present disclosure can advantageously be applied to situations in which one or more such systems are deployed in networked communication with a plurality of user computers, to enable crowdsourcing reputation analysis. In the simplest case, a single system is linked to multiple networked user computers, for example in an enterprise network environment. Here, when the system 150 prompts the user (as in steps 412 or 518), the prompt may include an inquiry as to whether the user of the user computer 120 wants to participate in a crowdsourcing process in which the responses of the particular user to one or more query will be fused with responses of other users to similar queries. The system 150 may prompt users of other user computers (e.g., at least a second user of a second user computer) to respond to one or more query corresponding to a request to retrieve the same web resource as requested by the user in step 402 or 502. The system 150 may aggregate the information, i.e., query responses, received from the various user computers to affect the risk level or reputation score re-calculation when generating the updated risk levels (reputations) or reputation scores presented to individual users. Specifically, the responses received from multiple user computers to queries, in response to user computer requests to browse to common web pages or web sites, may be aggregated/fused to generate updated reputation scores (risk levels). In the case where multiple systems (with each system operating according to the system 150) are deployed in networked communication with multiple user computers, each system may be assigned a subset of the user computers so as to form a cluster, where each cluster operates in accordance with the simplest case described above. In addition, the systems of each cluster may exchange and share information with each other to further affect the risk level or reputation score re-calculation when generating the updated risk levels/reputation scores. The aggregation, sharing and exchange of information may be used to advantage to reduce missed detections and false alarms in near real-time.

In the crowdsourcing embodiments described above, the query responses collected by the system 150 (or systems) from the plurality of users may be stored in a memory or a reputation database (linked to the system 150 or systems) for further analysis by the system 150 or systems.

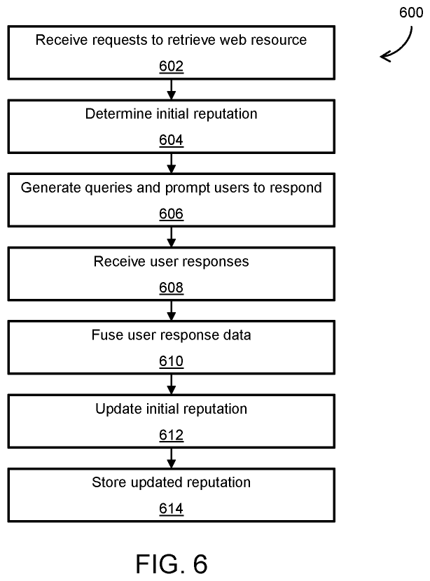

Attention is now directed to FIG. 6 which shows a flow diagram detailing a computer-implemented process 600 in accordance with embodiments of the disclosed subject matter. This computer-implemented process includes an algorithm for detecting phishing web resources based crowdsourced feedback. Reference is also made to the elements shown in FIGS. 1-3. The process and sub-processes of FIG. 6 are computerized processes performed by the system 150 including, for example, the CPU 154 (or the CPU 122 in embodiments in which the system 150 is deployed as a plug-in of the web browser 128) and associated components, such as the modules 158, 160, 162. The aforementioned processes and sub-processes are preferably performed automatically, and are preferably performed in real-time. It is noted that many of the steps of the process 600 are generally parallel executions of the steps described in the processes 400 and 500, and the details of those steps is not repeated here.

The process 600 begins at step 602, where the system 150 receives requests from a plurality of user computers (i.e., at least a first user computer and a second computer) to retrieve a web resource. The user computers may request to retrieve the same identical web resource (e.g., the user computers may request to open the same web page), or the user computers may request to retrieve substantially similar web resources (e.g., the web addresses identifying the requested web resources may have a common domain name, for example, the user computers may request to open different web pages of the same web site). At step 604, the system 150 determines the initial reputation of the requested web resource, and determines that the initial reputation is too poor to allow immediate retrieval of the requested web resource. At step 606, the system 150 generates queries addressable to each respective user of the respective user computers and prompts the users to respond to the respective queries. The prompts may include an inquiry as to whether each user wants to participate in the crowdsourcing activity. At step 608, the system 150 receives the user responses to the query prompts. At step 610, the system 150 fuses the user response data (i.e., aggregates or combines data gleaned from the user responses) from the users that affirm participation in the crowdsourcing activity. At step 612, the system 150 updates the initial reputation based on the initial reputation and the fused user response data to generate an updated reputation. At step 614, the updated reputation is stored in a memory or a reputation database (linked to the system 150). It is noted that the reputation of a web resource may be updated in a cascading or cumulative fashion, whereby the user response (to a query) provided by a first user is used to update the reputation associated with a request from a second user, and this updated reputation may be used to update the reputation associated with a request from a third user, and so on.

Note that in certain embodiments, the web client 128 may be selectively linked to one or more virtual browser that is remotely hosted (e.g., cloud server hosted) in an isolated or contained location. When using such a virtual browser mode, as the user browses to various web pages using the web client 128, the remote browser renders the active content of the web pages into images in real-time (or near real-time), which when displayed to the user via the web client 128 appears identical to the active content on the actual web page. The system 150 may, upon determining (in response step 418 of the process 400 or step 524 of the process 500) that a requested web resource has a poor reputation or high level of risk, offer the user the option of browsing to the requested web resource (having poor reputation, high risk) using such a virtual browser set-up.

It is noted that although the steps, performed by the system of the embodiments disclosed herein, for performing threshold tests via evaluation of reputation scores against various threshold criteria have been described within the exemplary context of high-value reputation scores being indicative of high risk, and low-value reputation scores being indicative of low risk, and evaluating reputation scores to determine whether the reputation scores are greater than, less than, greater than or equal to, or less than or equal to various threshold values, the particular low-score-low-risk, high-score-high-risk, threshold values and threshold test cases described in this document have been for illustrative purposes only. Cases in which high-value reputation scores are indicative of low risk and low-value reputation scores are indicative of high risk are considered to be within the scope of the present embodiments. Furthermore, for each instance where a reputation score is tested against a particular threshold to determine whether the reputation score is greater than, less than, greater than or equal to, or less than or equal to that particular threshold, it is also conceivable to evaluate the reputation score to determine whether the reputation score is less than or equal to, greater than or equal, less than, or greater than a particular threshold.

Furthermore, the reputation scoring examples, ranges, and thresholds used in the present document are strictly for example purposes, and the scope of the embodiments should not be limited to any particular example.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method, comprising:
receiving, from a web client of a client device, a request, addressed to a web server, to retrieve a requested web resource hosted by the web server;
determining an initial reputation associated with the requested web resource;
in response to determining the initial reputation, prompting a user of the client device to respond to at least one generated query corresponding to the requested web resource; and
updating the initial reputation associated with the requested web resource, based in part on at least one response to the at least one generated query received from the user, to generate an updated reputation associated with the requested web resource.

2. The method of claim 1, further comprising generating the at least one generated query in response to determining the initial reputation.

3. The method of claim 1, wherein determining the initial reputation includes checking for the presence of at least one of a web address or a domain associated with the requested web resource in one or more obtained list containing at least one of web addresses or domains.

4. The method of claim 1, wherein determining the initial reputation includes assigning a numerical reputation score to the requested web resource that quantifies an amount of risk associated with the requested web resource.

5. The method of claim 1, wherein determining the initial reputation includes analyzing at least one of: at least one string character or feature of a web address that identifies the requested web resource, at least one string character or feature of a domain associated with the requested web resource, at least one input field of the requested web resource, at least one string character or feature of the requested web resource, or entropy of words or characters in a domain associated with the requested web resource.

6. The method of claim 1, wherein determining the initial reputation includes identifying at least one anomaly associated with the requested web resource.

7. The method of claim 6, wherein the generated at least one query is generated according to at least one of the least one anomaly or the initial reputation.

8. The method of claim 1, wherein the at least one generated query includes a plurality of queries, the method further comprising: receiving a response to each query of the plurality of queries; and aggregating the received responses, and wherein updating the reputation includes modifying the initial reputation based in part on the aggregated responses.

9. The method of claim 1, wherein the initial reputation is represented by an initial reputation score, the method further comprising: sending the request to retrieve the requested web resource if the initial reputation score satisfies a first threshold criterion; and blocking the request to retrieve the requested web resource if the initial reputation score satisfies a second threshold criterion.

10. The method of claim 1, wherein the updated reputation is represented by an updated reputation score, the method further comprising: blocking the request to retrieve the requested web resource and adding at least one of a web address or a domain associated with the requested web resource to a black list if the updated reputation score satisfies a first threshold criterion; and sending the request to retrieve the requested web resource if the updated reputation score dissatisfies the first threshold criterion.

11. The method of claim 1, further comprising:
receiving, from a web client of a second client device, a request, addressed to the web server, to retrieve the requested web resource hosted by the web server;
prompting a user of the second client device to respond to a second at least one generated query corresponding to the requested web resource; and
updating the initial reputation associated with the requested web resource, based in part on:
at least one response to the at least one generated query received from the user of the user computer, and
at least one response to the second at least one generated query received from the user of the second user computer, to generate the updated reputation associated with the requested web resource.

12. The method of claim 1, further comprising notifying a user of the client device of the updated reputation associated with the requested web resource.

13. The method of claim 1, wherein the request to retrieve the web resource includes a request to open a web page.

14. A method, comprising:
receiving, from a web client of a client device, a request, addressed to a web server, to retrieve a requested web resource hosted by the web server;
obtaining an initial reputation score associated with the requested web resource; and
if the initial reputation score satisfies at least one threshold criterion:
generating at least one generated query corresponding to the requested web resource,
prompting a user of the client device to respond to the at least one generated query, and
updating the initial reputation score, based in part on at least one response to the at least one generated query received from the user, to generate an updated reputation score indicative of an updated reputation associated with the requested web resource.

15. The method of claim 14, wherein obtaining the initial reputation score includes identifying at least one anomaly associated with the requested web resource, and wherein the generated at least one query is generated according to at least one of the initial reputation score or the at least one anomaly.

16. The method of claim 14, further comprising:
receiving, from a web client of a second client device, a request, addressed to the web server, to retrieve the requested web resource hosted by the web server;
prompting a user of the second client device to respond to a second at least one generated query corresponding to the requested web resource; and
updating the initial reputation score, based in part on:
at least one response to the at least one generated query received from the user of the user computer, and
at least one response to the second at least one generated query received from the user of the second user computer, to generate the updated reputation score.

17. The method of claim 14, wherein the at least one generated query includes a plurality of queries, and the method further comprises: receiving a response to each query of the plurality of queries; and aggregating the received responses, and wherein updating the initial reputation score includes modifying the initial reputation score based in part on the aggregated responses to generate the updated reputation score.

18. The method of claim 14, further comprising: sending the request to retrieve the requested web resource if the initial reputation score satisfies a first threshold criterion; and blocking the request to retrieve the requested web resource if the initial reputation score satisfies a second threshold criterion.

19. The method of claim 14, further comprising: blocking the request to retrieve the requested web resource and adding at least one of a web address or a domain associated with the requested web resource to a black list if the updated reputation score satisfies a first threshold criterion; and sending the request to retrieve the requested web resource if the updated reputation score dissatisfies the first threshold criterion.

20. A method, comprising:
receiving, from a web client of a client device, a request, addressed to a web server, to retrieve a requested web resource hosted by the web server;
checking for the presence of at least one of a web address that identifies the requested web resource or a domain name associated with the requested web resource in at least one list, the at least one list comprising a plurality of elements having an associated common reputation, wherein the plurality of elements includes at least one of: one or more web address, or one or more domain name; and
if at least one of the web address that identifies the requested web resource or the domain name associated with the requested web resource is present in the at least one list:
generating at least one generated query corresponding to the requested web resource,
prompting a user of the client device to respond to the at least one generated query, and
updating an initial reputation associated with the requested web resource, based in part on at least one response to the at least one generated query received from the user, to generate an updated reputation associated with the requested web resource.
